(19) United States
(12) Patent Application Publication
(10) Pub. No.: US 2003/0151217 A1
(43) Pub. Date: Aug. 14, 2003

(54) Shopping cart with advertising display frames and business method

(76) Inventor: Antoine Trubiano, Montreal (CA)

Correspondence Address: David M. Carter, Carter & Schnedler, P.A., 56 Central Avenue, Suite 101, P.O. Box 2985, Asheville, NC, 28802, US

(21) Appl. No.: 10/074,383

(22) Filed: Feb. 12, 2002

(51) Int. Cl. B62D 39/00

(52) U.S. Cl. 280/33.997; 280/33.992

(57) ABSTRACT

A business method and a shopping cart for use with that method is described. The shopping cart has an articles carrying basket which is secured to a frame displaceable on casters by a user person. The basket has a bottom wall, opposed side walls, a front wall, a rear gate assembly and an open top end. The method comprises the steps of providing at least one display frame in a surface of at least one of the front wall and opposed side walls. A promotional sheet having display material thereon is also provided for removable attachment to the at least one display frame. The display material contains an imagery and/or written material of promotional content whereby to increase the sale of a promotional product which is displayed or described on the sheet and for a predetermined period of time. The promotional sheet is changed after the predetermined period of time to provide a further promotion during a further predetermined period of time.

### TECHNICAL FIELD

The present invention relates to a shopping cart having advertising display frames on the side walls and/or front wall thereof whereby to carry promotional material which is visible to a user person and the business method wherein the promotional material generates additional income to a proprietor of the shopping cart by increasing sales and providing a payback of the shopping cart.

### BACKGROUND ART

Heretofore shopping carts have been provided wherein a panel may be affixed to the outer surface of the front wall thereof to carry advertising material or simply a photograph or a design whereby to enhance the appearance of the shopping cart. Such material carried by such frame is however of a permanent nature. It is also known to fabricate shopping carts with plastic molded baskets and wherein on the side wall of the basket there is provided a small plaque which is usually rectangular in outline and which carries in a permanent embossed nature the name of the merchandising establishment or the name of the fabricator of the shopping cart. Accordingly, it has been known to display written material or advertisement on the outer surface of the front wall or side walls of a shopping cart basket but in most cases such has been provided for permanent display.

### SUMMARY OF INVENTION

It is a feature of the present invention to provide a business method which includes a shopping cart and wherein one or more display frames are provided in the side walls and front wall of a shopping cart whereby to removably secure promotional advertisement in sheet form to increase the sale of a promotional product and to generate additional revenue to a proprietor of the shopping cart.

Another feature of the present invention is to provide a shopping cart for use with the above mentioned business method and wherein a display frame is provided on the inner surfaces of the side walls of the shopping cart basket whereby advertising material removably securable to such frames are visible to a shopping person when standing to the side of the shopping cart and/or to the inner surface of the front wall of the basket whereby to make such advertising material visible to a user person pushing such cart from the rear end thereof.

Another feature of the present invention is to provide a shopping cart for use with a business method and wherein the display frames are provided on the inner and outer surfaces of both side walls and/or front wall of the shopping cart basket.

According to the above features, from a broad aspect, the present invention provides a business method including a shopping cart having an articles carrying basket secured to a frame displaceable on casters by a user person. The basket has a bottom wall, opposed side walls, a front wall, a rear gate assembly and an open top end. The method comprises the steps of providing at least one display frame in a surface of at least one of the front wall and opposed side walls. A promotional sheet having display material thereon is removably attachable to the at least one display frame. The display material contains an imagery and/or written material of promotional content to increase the sale of a promotional product which is displayed or described on the sheet and for a predetermined period of time. The promotional sheet may be changed after the predetermined period of time to provide a further promotional sheet during a further predetermined period of time.

According to a further broad aspect of the present invention there is provided a shopping cart having an articles carrying basket as above-described and for use in a business method as also above described.

According to a further broad aspect of the present invention the at least one display frame is provided on the inner surface of the opposed side walls of the shopping cart basket and/or of the front wall.

### BRIEF DESCRIPTION OF DRAWINGS

A preferred embodiment of the present invention will now be described with reference to the accompanying drawings in which:

FIG. 1 is a fragmented perspective view of a shopping cart provided with advertising display frames for use in the business method of the present invention;

FIG. 2 is a simplified schematic view illustrating how a user person has access to the advertising material which is removably secured to the display frames located on the inner surface of the side walls of the shopping cart basket of the present invention;

FIG. 3 is a fragmented view of the shopping cart basket showing the position of a display frame on the inner surface of the front wall of the shopping cart basket;

FIG. 4 is a perspective view of a shopping cart basket constructed in accordance with the present invention and wherein display frames are provided on the outer surfaces of the side wall and front wall of the basket;

FIG. 5 is a fragmented view showing the construction of a display frame and the manner in which a promotional sheet is detachably secured to the frame;

FIG. 6 is a fragmented section view through a display frame formed in the side walls or front wall of a shopping cart basket constructed in accordance with the present invention; and

FIG. 7 is a side view showing a display frame which is secured to the wire rods of a shopping cart basket and providing for the removable securement of promotional sheet material both internally and externally of the shopping cart wall.

### DESCRIPTION OF PREFERRED EMBODIMENTS

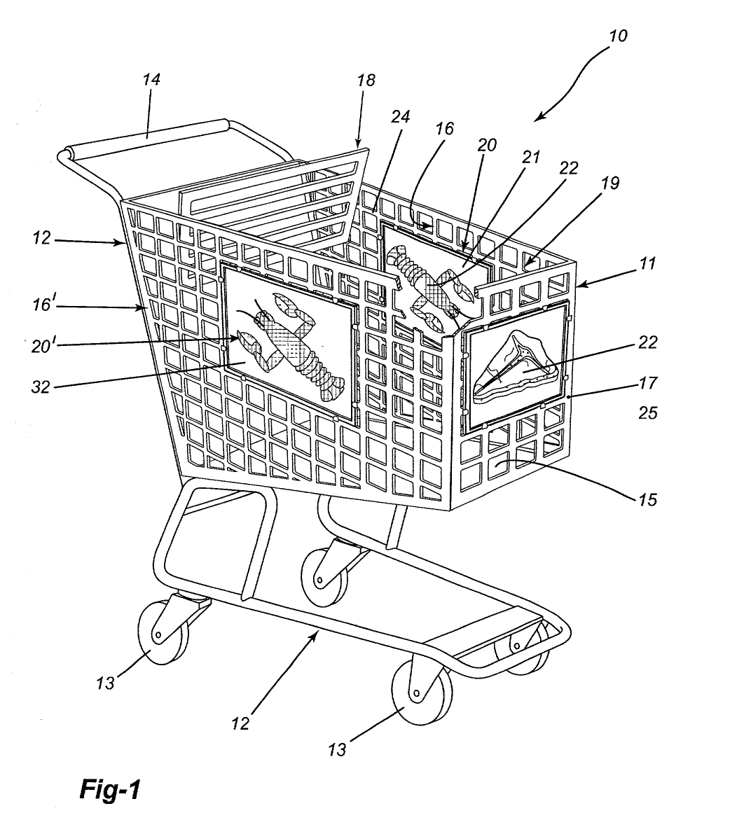

Referring now to the drawings and more particularly to FIG. 1, there is shown generally at 10 a shopping cart of common construction and wherein a shopping cart basket 11 is secured to a support frame 12 mounted on casters 13 whereby to displace the shopping cart over a floor surface by means of a handle bar 14 secured to the frame 12 or formed integrally thereof and located rearwardly of a shopping cart. The shopping cart basket 11 has a bottom wall 15, opposed side walls 16, a front wall 17, a rear gate assembly 18 and an open top end 19. During use, the shopping cart is pushed by a user person through aisles in a shopping establishment and articles are placed into the basket 11 as is well known in the art.

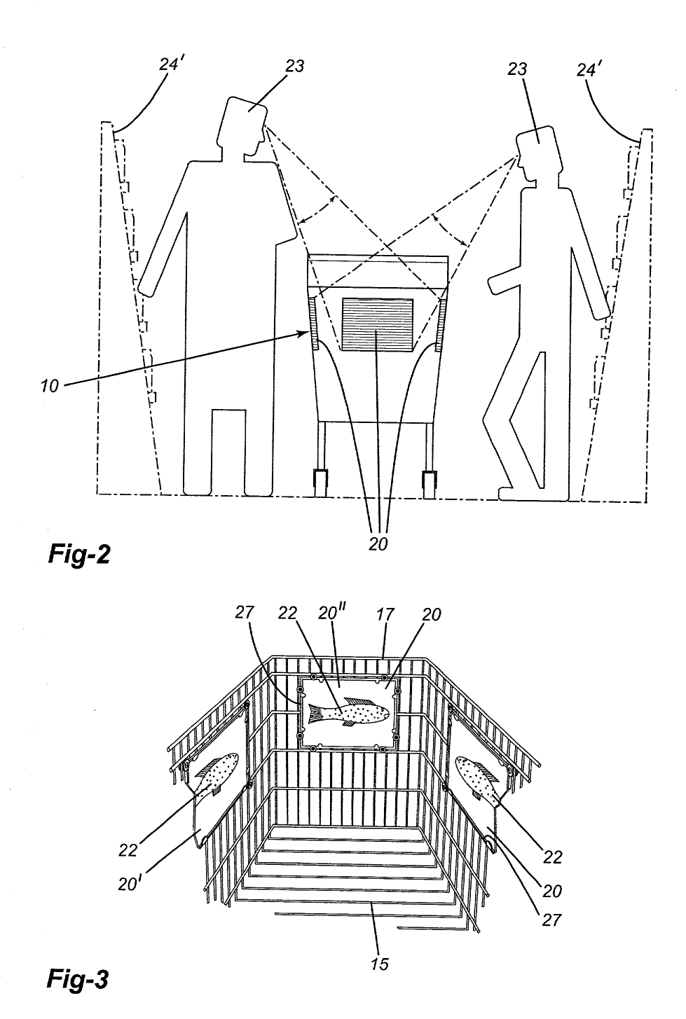

The present invention provides a business method wherein the shopping cart is provided with at least one display frame 20 secured to a surface of at least one of the front wall 17 or opposed side walls 16 and 16′. As hereinshown, a display frame 20 and 20′ is provided in the opposed side walls 16 and 16′. A promotional sheet 20 is secured to the display frame 20 and carries display material 22 thereon. As shown in this Figure, the display material is a lobster photograph or design whereby to suggest to a user person to buy such a product or seafood products. The frame 20 is also secured to the inner surface 24 of a side wall 16 and visible from the side of the shopping cart 10 as is illustrated with further reference to FIG. 2. As can be seen in FIG. 2, the user person 23 has access to the display frame when the shopping cart is in use by a user person and the user person is retrieving products from the shelving 24 to the side of the shopping cart and this, from both sides of the shopping cart.

The display material 22 on the frame 20 facing inwardly of the shopping cart basket may be different from the display material on the frame 20′ on the opposed side wall and facing inwardly of the basket as the business method of the present invention provides for deriving revenue from such display material. Accordingly, the promotional sheet is provided as a removably attachable sheet to change the advertisement.

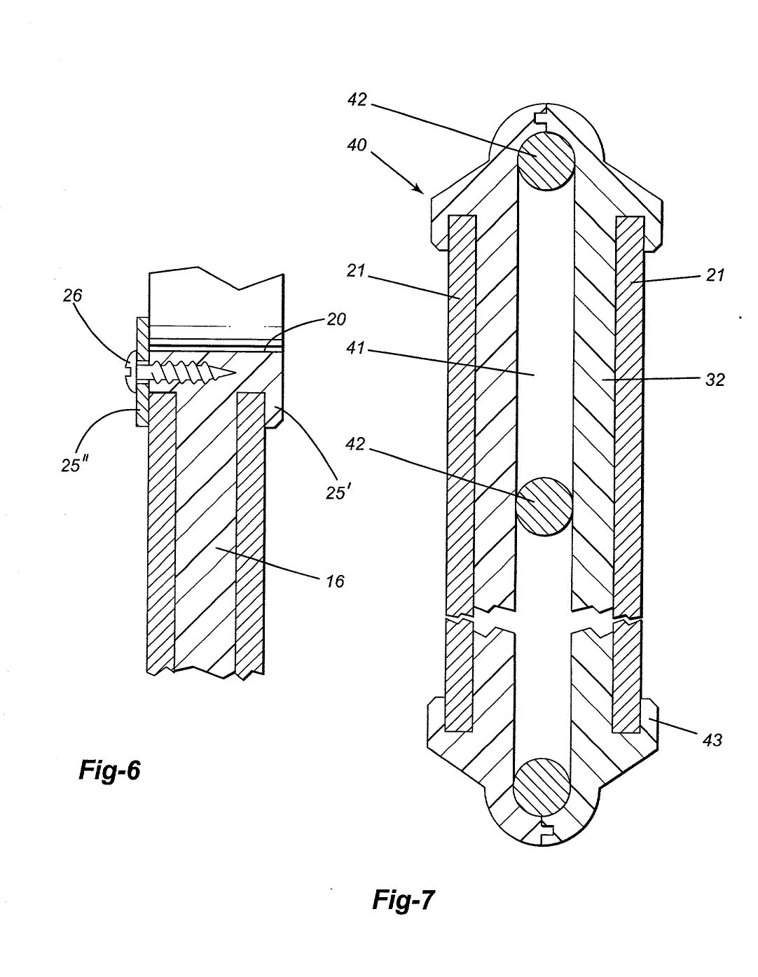

Referring to FIGS. 5 and 6, it can be seen that the frame 20 is provided with attachment means 25 in the form of integrally formed flanges 25′. These flanges are formed with the side wall 16 which is hereinshown in FIG. 6 as being constituted by an injected molded basket side wall 16. The attachment means 25 may also be constituted by clips 25″ which are secured about the frame 20 by fasteners 26 and as is shown in FIG. 5, the promotional sheet 21 is simply positioned under these flanges 25′ or clips 25″ whereby they can be easily removed and replaced. Therefore, the sheet has rigidity such as a plastic laminated advertising sheet. The sheets 21 are also preferably formed of waterproof material such as plastic sheets that can retain an image or written and printed material and resistant to wear by product placed thereagainst. By providing an advertising image and/or written material on the promotional sheet, sales of the promotional product are generally increased, as these are continuously visible to the user of the shopping cart and suggestive of a product or products. In the business method of the present invention it is intended that such advertising material be sold for predetermined periods of time whereby the advertising sheet or panels can be changed after the predetermined period of time has lapsed. The advertising cost can also vary depending on festive seasons, such as holiday periods. Also, when leasing the advertisement, such cost can vary dependent on the quantity of shopping carts equipped with a customer's advertisement. Thus, the carts can advertise several products at the same time.

The business method also comprises the provision of a frame 20″ over the inner surface 27 of the front wall 17 of the shopping cart whereby the advertising display material 22 is visible from a user person standing rearwardly of the shopping cart 10, such as when pushing the cart, or to the sides thereof when filling the cart basket with goods. In this position the advertising material is usually always visible to the user person as well as the material on the side frames 20 and 20′. Accordingly, display material can be provided on both the inner surface of the side walls and the front wall and the display material can be for various predetermined periods of time. Therefore, the promotional sheet material inside the shopping cart may be different on the side walls and the front wall.

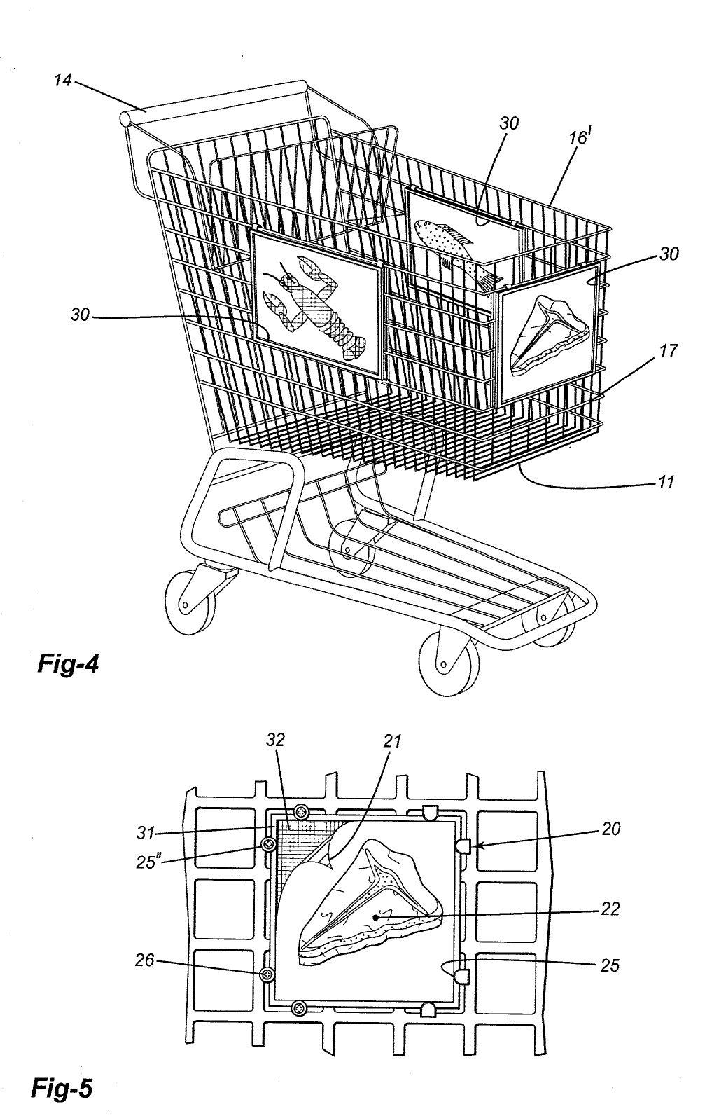

As shown in FIG. 4, additional display frames 30 may be provided on the outer surfaces of the side walls 16 and 16′ and the front wall 17 and in registry with the frames on the inner surfaces of these walls to provide additional promotional sheet materials on the outer surfaces. This is visible to other persons in a shopping establishment. It is also conceivable that more than one display frame could be provided on either or both the inner and outer surfaces of the side walls and front wall of the shopping cart basket.

As shown in FIGS. 4, 5 and 6, the basket is an injected plastic molded basket and the frames have a contour wall 31 and a flat rear panel 32. Therefore, it is conceivable that the advertising sheet material 21 could be adhesively secured to the panels 32 with a peelable adhesive or with other types of adhesives that facilitate the interchangeability of these promotional sheets 21.

Referring now to FIG. 7, there is shown a further construction of a display frame 40 wherein the display frame is formed in two sections 41 and 41′ which are clampingly secured to a side wall or front wall of a wire-type basket which is constructed of wire rods 42. The frame sections 41 and 41′ are clamped together by a suitable means not shown but obvious to a person skilled in the art. Accordingly, one section 41 lies over the outer side of the shopping cart basket wherein the section 41′ is over the inside surface of the shopping cart side walls or front wall. These sections are also provided with flanges or other attachment means 43 to secure the promotional sheets 21 thereto.

Accordingly, the present invention provides a business method whereby to generate additional revenue to a proprietor of the shopping cart by increasing sales and providing a payback to the proprietor of the shopping cart thereby facilitating the sale of shopping carts incorporating the business method of the present invention and a shopping cart basket as above described having display frames strategically located to generate additional revenue.

It is within the ambit of the present invention to cover any obvious modifications of the preferred embodiment described herein provided such modifications fall within the scope of the appended claims.

I Claim:

1. A business method including a shopping cart having an articles carrying basket displaceable on casters by a user person; said basket having a bottom wall, opposed side walls, a front wall, a rear gate assembly and an open top end; said method comprising the steps of:
i) providing at least one display frame in a surface of at least one of said front wall and opposed side walls;
ii) providing a promotional sheet having display material thereon for removable attachment to said at least one display frame, said display material containing an imagery and/or written material of promotional content to increase the sale of a promotional product which is displayed or described on said sheet and for a predetermined period of time, and
iii) changing said promotional sheet after said predetermined period of time to provide a further promotional sheet of a different promotional product during a further predetermined period of time.

2. A business method as claimed in claim 1 wherein said at least one display frame is provided with attachment means for removably retaining said promotional sheet therein, and said step (ii) comprises attaching said promotional sheet in said display frame by said attachment means.

3. A business method as claimed in claim 2 wherein said attachment means comprises clips provided at spaced intervals along the periphery of said frame, said step (ii) comprises disposing said promotional sheet in said frame with peripheral portions of said promotional sheet disposed under said clips for removable retention thereby in said frame.

4. A business method as claimed in claim 1 wherein said step (i) comprises the step of providing a display frame on an inner surface of said opposed side walls of said basket and said step (ii) comprises attaching a promotional sheet in both display frames, said promotional sheet in said frames on said inner surface of said opposed side walls being visible from a respective side of said basket.

5. A business method as claimed in claim 1 wherein said step (i) comprises the step of providing a display frame on an inner surface of said front wall of said basket, and said step (ii) comprises attaching said promotional sheet in said display frame on said inner surface of said front wall whereby said promotional sheet is visible from the rear of said basket and opposed sides thereof.

6. A business method as claimed in claim 1 wherein said step (i) comprises the step of providing a display frame on an inner surface of said opposed side walls and front wall of said basket and said step (ii) comprises removably attaching one of said promotional sheets to each said frame, said promotional sheet attached to said frames containing like or unlike display material.

7. A business method as claimed in claim 6 wherein said step (i) comprises further providing additional display frames on an outer surface of said side walls and front wall in registry with said frames on said inner surfaces thereof, and said step (ii) comprises attaching further ones of said promotional sheet to said frames on said outer surfaces.

8. A business method as claimed in claim 1 wherein said frames are integrally formed with said basket, said basket being formed of plastics material, said promotional sheet being recessed from an outer face of said surface.

9. A business method as claimed in claim 1 wherein there is further provided the steps of (a) providing a chargeable rate for the placement of said promotional sheet in said frame during said predetermined period of time, (b) providing a further chargeable rate for predetermined quantities of shopping carts provided with the promotional sheet of step (a), whereby to generate additional revenue to a proprietor of said shopping cart by increasing sales and providing a payback of said shopping cart.

10. A business method as claimed in claim 9 wherein said display material is constituted by images of products associated with a merchandising enterprise, said promotional sheet being fabricated as a waterproof promotional sheet.

11. A shopping cart having an articles carrying basket as defined in the preamble of claim 1 for use in a business method as defined in claim 1.
